(19) United States
(12) Patent Application Publication
(10) Pub. No.: US 2009/0112756 A1
(43) Pub. Date: Apr. 30, 2009

(54) METHOD AND SYSTEM FOR PROCESSING NEGOTIABLE INSTRUMENTS

(75) Inventors: William D. Haselden, Birmingham, AL (US); Daryl James McDaniel, Trussville, AL (US)

Correspondence Address: STEPTOE & JOHNSON LLP, 1330 CONNECTICUT AVENUE, N.W., WASHINGTON, DC, 20036, US

(73) Assignee: Regions Asset Company, Wilmington, DE (US)

(21) Appl. No.: 12/257,018

(22) Filed: Oct. 23, 2008

Related U.S. Application Data
(60) Provisional application No. 60/982,316, filed on Oct. 24, 2007.

(51) Int. Cl. G06Q 40/00

(52) U.S. Cl. 705/39

(57) ABSTRACT

A method and system for processing information is provided. A negotiable instrument may be scanned to determine a first amount and a second amount. A comparing module compares the first amount to the second amount, and a value for the negotiable instrument is determined based on the amounts. The value can be compared to the amounts to determine if a predetermined error has been committed in entering the value. If so, the value may be corrected.

### CLAIM OF PRIORITY

This application claims priority to Provisional U.S. Patent Application No. 60/982,316, filed Oct. 24, 2007, which is incorporated by reference in its entirety.

### TECHNICAL FIELD

The invention relates to a method for reducing errors in check processing.

### BACKGROUND

The automation of processing negotiable instruments, such as checks, has allowed financial institutions to process high numbers of checks with fewer operators. Since financial institutions require fewer operators per customer, they have been able to reduce costs per customer, which has saved them money and allowed them to expand to accommodate increased numbers of customers.

Current methods of check processing include scanning a check to obtain the value of the check, and entering that value in a database. A value is determined by the courtesy amount, written as numbers on a check, and a legal amount, which is handwritten or typed with letters on a check. Advanced handwriting recognition programs allow financial institutions to analyze the legal amount electronically. The value of the legal amount may then be compared to the courtesy amount.

In most cases, the amounts match, and the check can be automatically processed by the financial institution. Its correct value is entered in a database, and the funds are cleared to be transferred from the account holder to the payee. But if the check processing system determines that the values of the legal amount and the courtesy amount differ, the check may be sent to an operator, who can manually enter the correct value of the check. The operator may have access to the check itself, with the courtesy and legal amounts, and also to any payment coupons that may have accompanied the check.

For example, many customers send payments to financial institutions for loans or bill payment. Such a system is called a lockbox environment. When customers send loan coupons to financial institutions with a payment check, the processing system can analyze the check and the coupon to determine the correct value of the check. If there is a discrepancy between the values of the courtesy amount, legal amount, and coupon amount, the coupon and check may be made available to operators, either in electronic form or physically. The operator may then determine the correct check value.

The operator analysis of the check amounts and entry of a new check value may catch most check errors, but the operator may commit further errors. Common operator errors include entering a key twice by mistake, or placing too many zeros in a check value. Although the resulting check value entries differ from the correct value by only one digit, this may create a discrepancy of hundreds or thousands of dollars. Such discrepancies may be expensive and time-consuming to correct, and they can damage client relationships.

Currently, there is no efficient method in the financial industry of catching errors committed by operators, where the check has been sent to the operator after a discrepancy in the legal and courtesy amounts. Current methods can generally produce accuracy rates in excess of 99.9%. But even if only one in every thousand checks is processed incorrectly, large financial institutions process such large volumes of checks that correcting errors can still be expensive and time-consuming.

### SUMMARY OF THE INVENTION

A method for correcting check processing errors can include steps that make the process more efficient, inexpensive, and easy to implement. The method can utilize information already within a database, reducing the need for new complex programming or data acquisition. The method also does not require an infusion of manpower; rather, a few operators can review flagged entries from any location with access to a financial institution's database. Unexpectedly, the method can reduce the occurrence of encoding errors during check processing to fewer than 1 in 50,000 processed checks, or even fewer than 1 in 100,000 processed checks. In certain circumstances, the occurrence of encoding errors can be reduced to between 1 in 250,000 processed checks or less.

In one aspect, a method for processing information includes obtaining a first amount and a second amount from a transaction, comparing the first amount and the second amount, entering a transaction value into a database based on the first amount and the second amount, and flagging the transaction value in a database when the transaction value differs by one digit from the first or second amount, or when the transaction value differs from the second amount and the second amount is determined to have a specified degree of accuracy. The transaction can include a negotiable instrument, such as a check.

In another aspect, the first amount and the second amount are obtained by scanning a document, such as a check.

In yet another aspect, the first amount and the second amount are compared electronically.

In yet another aspect, a flagged transaction value is sent to an operator.

In yet another aspect, the operator analyzes at least one of the transaction value and first and second amounts.

In yet another aspect, the transaction value is flagged in a database when the transaction value differs from the first or second amount by a factor of ten.

In yet another aspect, the transaction value is flagged in a database when the transaction value differs from the first or second amount by a factor of one hundred.

In yet another aspect, before flagging said transaction value, a transaction value is manually entered into a database if the first amount is not the same as the second amount.

In yet another aspect, a transaction value is flagged in a database if the first amount contains a double key press.

In yet another aspect, the specified degree of accuracy is at least 80 percent.

In yet another aspect, the specified degree of accuracy is at least 90 percent.

In another aspect, a method for processing information includes determining a first value and a second value of a document, comparing the first value to the second value, entering a document value based on the first value and the second value, and flagging the document value in a database if the length of the document value differs by one character from the length of either one of the first and second values, or when the document value differs from either one of the first and second values and the either one of the first and second values determined to have a specified degree of accuracy.

In yet another aspect, the first value and the second value are determined by scanning the document.

In yet another aspect, the first value and the second value are compared electronically.

In yet another aspect, a flagged document value is sent to an operator.

In yet another aspect, the operator analyzes at least one of the document value and first and second values.

In yet another aspect, the document value is flagged in a database when the document value differs from the first or second value by a factor of ten.

In yet another aspect, the document value is flagged in a database when the document value differs from the first or second value by a factor of one hundred.

In yet another aspect, before flagging the document value, the document value is manually entered into a database if the first value is not the same as the second value.

In yet another aspect, the document value is flagged in a database if the first amount contains a double key press.

In another aspect, a system for processing information includes a scanner configured to obtain a first value and a second value from a document and a comparison module configured to compare the first value to the second value thereby identifying a predetermined error.

In yet another aspect, the system further includes a correction module configured to receive a corrected value for the document.

In yet another aspect, the document is a negotiable instrument.

In yet another aspect, the first value is a courtesy amount.

In yet another aspect, the second value is a legal amount.

In yet another aspect, the predetermined error includes a double key press.

In yet another aspect, the predetermined error includes a difference of a factor of ten between the first or second value and a document value.

In yet another aspect, the predetermined error includes a difference of one digit between either the first value or second value and a document value.

In yet another aspect, the predetermined error includes a difference between either the first value or second value and a document value.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a block diagram illustrating a method for processing a negotiable instrument.

FIG. 2 is a depiction of database entries.

FIG. 3 is a block diagram representing a system for processing a negotiable instrument.

### DETAILED DESCRIPTION

Although the following detailed description contains many specific details for the purposes of illustration, anyone of ordinary skill in the art will appreciate that many variations and alterations to the following details can be incorporated in the system and methods described herein. Accordingly, the exemplary embodiments described below are set forth without any loss of generality to, and without imposing limitations upon, any claimed invention.

A detailed explanation of the method and process according to preferred embodiments of the present invention are described below.

A customer delivers a negotiable instrument, such as a check, to a financial institution. Often the negotiable instrument is accompanied by a payment receipt or coupon. The negotiable instrument may be for payment to the financial institution itself, or for payment to another party. This system of receiving and processing negotiable instruments from customers or clients of customers is often referred to as a retail lockbox system.

The financial institution obtains two values from the negotiable instrument: a numerical “courtesy” value and an alphabetically written “legal” value. The values may be obtained by a manual inspection, by scanning, or by any other means. The payment coupon may also be used to help determine the correct value of the negotiable instrument. The coupon usually has an OCR scan line with a dollar amount in the scan line which is entered into the database. The coupon may also have a typed value, but a customer may hand-write a value onto the coupon as well.

To reduce costs and manpower needed to process negotiable instruments, financial institutions often convert physical documents into digital form for processing. First, the negotiable instrument and associated coupon are scanned, and the electronic images are stored in a database. A computer system analyzes the images to determine the courtesy amount and legal amount of the check, corresponding to the numerical and alphabetically-represented values. The system may also analyze the coupon to determine the desired value. If the courtesy amount and legal amount do not match, or if either of these amounts does not match the payment coupon, the images may be sent to an operator for processing. The courtesy and legal amounts match if the numerically-represented value is the same as the alphabetically-represented value.

The operator analyzes the images of the negotiable instrument and associated payment coupon and enters a value for the negotiable instrument in the database. A computer system then analyzes the entered value for the negotiable instrument, and determines whether the digital values should be forwarded to a second operator for error-checking.

For example, if the first operator's entry differs from either the legal amount or the courtesy amount by one digit, all three values are forwarded to a second operator. Further, if the first operator's entry differs from either the legal amount or courtesy amount by a factor of ten or 100, all three values are forwarded to a second operator. Further, if the difference between the first operator's entry and the courtesy or legal amounts is a double-key, all three values are forwarded to a second operator. And if the quality of the scan is such that the value of the courtesy or legal amount has a surety value, or a likelihood that it is correct, of a given level, all three values are forwarded to a second operator.

The predetermined surety level need not be at any one specific level, but may depend on the circumstances. For example, one financial institution may wish to forward values when there is only a 50% surety level. Another may wish to forward only those values with a surety level of 55% or 60%. However, to reduce the need for a second operator, it is preferred that the surety level be at least 80%, and more preferably at 90%.

The second operator need not be a pre-designated operator. Rather, the value can be flagged in a database, and any operator with access to the database may compare the image of the negotiable instrument and payment coupon against the entered value to check for errors.

Once the second operator checks for errors, the negotiable instrument is preferably processed without further review. Thus, an efficient system and method for processing negotiable instruments can be implemented using information already in a financial institution's database and without hiring additional operators.

Rather than being analyzed electronically, the negotiable instrument value may also be entered manually. In such a case, a first operator examines the negotiable instrument and any associated coupon and enters a value in a database. The instrument may then be sent to a second operator for error checking. If there is an error, the second operator enters a corrected value in the database. The first and second entries are then compared, and if they do not match, the negotiable instrument can be sent to a third operator for error checking.

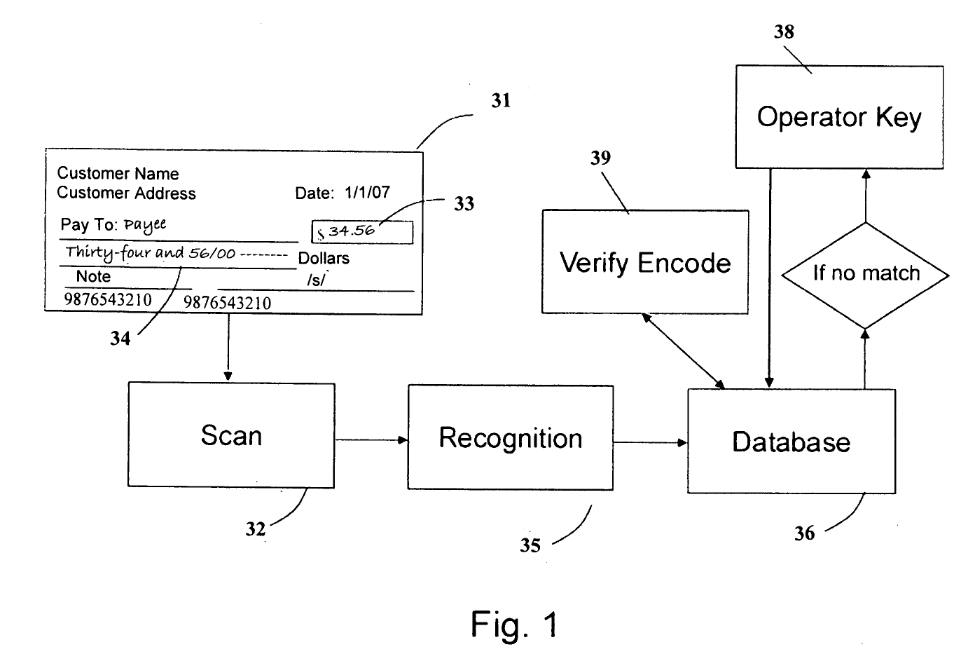

The following is a more detailed description of the drawings. FIG. 1 is a block diagram which illustrates the method for verifying check values. Block 1 represents scanning a check 31 into a database 36. The check has a numerical courtesy amount 33 and an alphabetically-represented legal amount 34. A payment coupon or loan remittance coupon may also be scanned by a device 32. The check is analyzed by recognition software 35. The recognition software 35 analyzes the scanned check and scanned loan coupon and generates digital values for the courtesy amount 33 and the legal amount 34 and enters them into a database 36. The database 36 also contains the scanned image of the check 31.

The values of the courtesy and legal amounts are analyzed to determine whether they match. The analyzed values are preferably the digital values obtained by scanning the check and the payment coupon, but may be the physical documents. The courtesy and legal amounts are considered “matching” when the value represented in the numerical courtesy amount is the same as the value represented in the alphabetical legal amount. If they do not match, the scanned image is sent to an operator 38 to analyze the correct value and enter the value into the database 36.

The value entered by the operator 38 is compared with the digital value of either the courtesy amount 33 or the legal amount 34. If the value entered by the operator 38 differs by one digit from the digital values of the courtesy amount 33 or the legal amount 34, the value entered by the operator 8 and the digital values of the courtesy amount 33 or the legal amount 34 are sent to another operator, represented by box 39 in FIG. 1, to check for erroneous data entry. The second operator may be at any location with access to the database 36.

For example, if the digital value of the courtesy amount, obtained by scanning a negotiable instrument, is $525.00, and the value entered by the operator is $522.00, the entry for the check value would be flagged. Such a difference of one digit is fairly common, since an operator may press a key adjacent to the correct key, and may not catch the error. The flagged entry may then be sent to a second operator, or to a database where any operator with access to the database may access the entry, analyze the entered value and scanned images, and fix the error.

Also, if the surety level of the scan is of a certain level, preferably 90% or higher, and if the digital value of either the courtesy amount or the legal amount is different from the value entered by the operator, the digital value of the courtesy amount or the legal amount and the value entered by the operator is sent to a second operator to check for erroneous data entry.

For example, if the digitally obtained courtesy value of a check is $525.25 and the value entered by the operator is $252.52, and if the surety level is 97% that the $525.25 value is accurate and the system requires a 90% surety level, then the check entry may be flagged. The system may then send the flagged entry to an operator, or it may leave the flagged entry in a database, where any operator with access to the database may access the entry, analyze the entered value and scanned images, and fix the error.

Additionally, the values may be analyzed for other potential errors, such as double digit entries or extra zeros, and sent to a second operator to check for erroneous data entry if such conditions are met. For example, if the digitally-obtained courtesy value is $325.05 and the value entered by the operator is $3,325.05, the entry may be flagged. And if the courtesy value is $325.05 and the entered value is $3,250.50, the entry may also be flagged. The system may then send the flagged entry to an operator, or it may leave the flagged entry in a database, where any operator with access to the database may access the entry, analyze the entered value and scanned images, and fix the error.

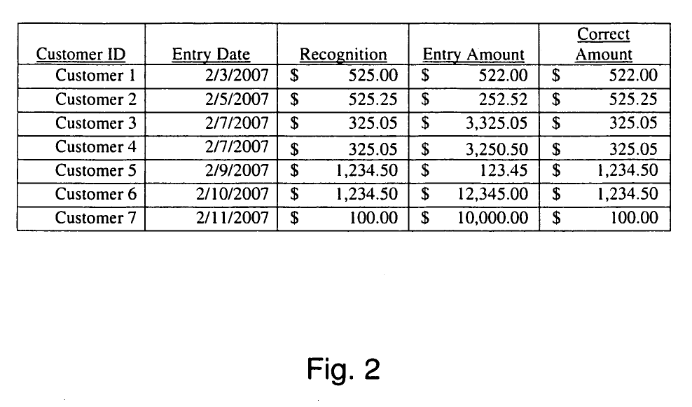

FIG. 2 illustrates a sample database page. The page may include information such as a customer identification entry box, a date of entry box, an entered amount box, a recognized amount box, and a correct amount box. The customer identification box would provide a way to identify the payor of the check. The date of entry box contains the date on which the operator entered the check amount. The entered amount is the amount entered by the operator. The recognized amount can be either the courtesy amount or legal amount recognized by the recognition software 6. The correct amount box is where a second operator could enter the amount of the check if the system determined a common operator error, such as those described above, had occurred. The second operator could access the database to look at the recognized amount and the amount entered, and could also have access to the digital images of the check and the payment coupon. The second operator could then determine whether a common data entry error occurred, and if it did, the second operator would enter a correct value in the database.

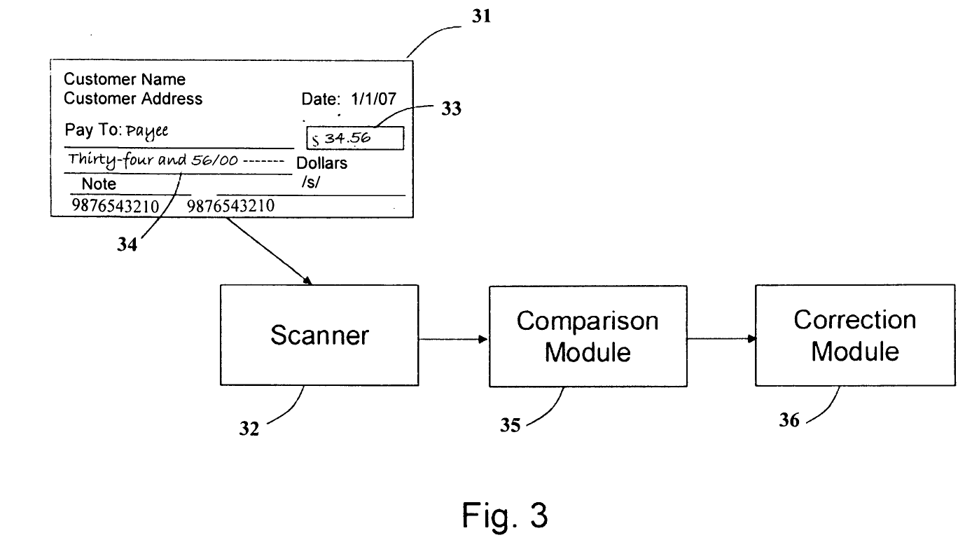

FIG. 3 illustrates an embodiment of a system for implementing the present invention. Document 31 is scanned in a scanner 32. The document 31 is preferably a negotiable instrument, such as a personal check. The scanner 31 scans the check, generating digital values for the numerical courtesy amount 33 and alphabetical legal amount 34. This digital data is compared in a comparison module 35. The comparison module 35 is preferably a computer system programmed to compare data. If the digital amounts are the same, their value is set as the check value, and the funds are made available to the payee. If the digital amounts are not the same, the scanned image of the check is analyzed and a value for the check is determined.

The comparison module then compares the check value to the digital amounts for the courtesy amount or the legal amount to check for predetermined errors. Such errors may include a difference of a factor of ten, a difference of a factor of one hundred, a double key press, a misplaced decimal, or others. If such errors are detected, the check information may be sent to a correction module 36 to cure the discrepancy. The correction module may be a computer database accessible by operators at remote locations, for example. Once the check information is cleared from the correction module, the funds indicated on the check may be made accessible to the payee.

The present method and system can have the unexpected benefit of drastically reducing encoding errors. The table below illustrates results from two test implementations of the system by a financial institution.

Ratio of Encoding
Errors to
Total Volume

| Month | Test 1 | Test 2 |
|---|---|---|
| 1 | 1:49,272 | 1:36,045 |
| 2 | 1:39,802 | 1:43,918 |
| 3 | 1:48,237 | 1:59,711 |
| 4 | 1:53,138 | 1:44,968 |
| 5 | 1:40,103 | 1:32,634 |
| 6 | 1:49,612 | 1:51,208 |
| 7 | 1:89,101 | 1:79,842 |
| 8 | 1:105,969 | 1:162,776 |
| 9 | 1:135,757 | 1:149,337 |

The above table shows that in the first test, previous to implementing the system that is the basis of the present invention, between 1:39,802 and 1:53,138 checks would have an encoding error. After implementing the system in month 7, the encoding error rate dramatically dropped, reaching 1:135,757 in month 9.

In the second test, previous to implementing the system that is the basis of the present invention, between 1:32,634 and 1:59,711 checks would have an encoding error. After implementing the system in month 7, the encoding error rate dramatically dropped, reaching 1:162,776 in month 8 and 1:149,337 in month 9.

The embodiments disclosed herein have the benefit of utilizing information already being collected by the industry to drastically reduce the number of errors in check processing. It allows any person with access to the check database to act as a second operator to check for data entry errors. Although preferred embodiments are disclosed herein, the invention is not limited to the disclosed embodiments.

The various techniques, methods, and systems described above can be implemented in part or in whole using computer-based systems and methods. Additionally, computer-based systems and methods can be used to augment or enhance the functionality described above, increase the speed at which the functions can be performed, and provide additional features and aspects as a part of or in addition to those described elsewhere in this document. Various computer-based systems, methods and implementations in accordance with the above-described technology are presented below.

In one implementation, a general-purpose computer can have an internal or external memory for storing data and programs such as an operating system (e.g., DOS, Windows 2000™, Windows XP™, Windows NT™, OS/2, UNIX or Linux) and one or more application programs. Examples of application programs include computer programs implementing the techniques described herein, authoring applications (e.g., word processing programs, database programs, spreadsheet programs, or graphics programs) capable of generating documents or other electronic content; client applications (e.g., an Internet Service Provider (ISP) client, an e-mail client, or an instant messaging (IM) client) capable of communicating with other computer users, accessing various computer resources, and viewing, creating, or otherwise manipulating electronic content; and browser applications (e.g., Microsoft's Internet Explorer) capable of rendering standard Internet content and other content formatted according to standard protocols such as the Hypertext Transfer Protocol (HTTP).

One or more of the application programs can be installed on the internal or external storage of the general-purpose computer. Alternatively, in another implementation, application programs can be externally stored in and/or performed by one or more device(s) external to the general-purpose computer.

The general-purpose computer includes a central processing unit (CPU) for executing instructions in response to commands, and a communication device for sending and receiving data. One example of the communication device is a modem. Other examples include a transceiver, a communication card, a satellite dish, an antenna, a network adapter, or some other mechanism capable of transmitting and receiving data over a communications link through a wired or wireless data pathway.

The general-purpose computer can include an input/output interface that enables wired or wireless connection to various peripheral devices. Examples of peripheral devices include, but are not limited to, a mouse, a mobile phone, a personal digital assistant (PDA), a keyboard, a display monitor with or without a touch screen input, and an audiovisual input device. In another implementation, the peripheral devices can themselves include the functionality of the general-purpose computer. For example, the mobile phone or the PDA can include computing and networking capabilities and function as a general purpose computer by accessing the delivery network and communicating with other computer systems. Examples of a delivery network include the Internet, the World Wide Web, WANs, LANs, analog or digital wired and wireless telephone networks (e.g., Public Switched Telephone Network (PSTN), Integrated Services Digital Network (ISDN), and Digital Subscriber Line (xDSL)), radio, television, cable, or satellite systems, and other delivery mechanisms for carrying data. A communications link can include communication pathways that enable communications through one or more delivery networks.

In one implementation, a processor-based system (e.g., a general-purpose computer) can include a main memory, preferably random access memory (RAM), and can also include a secondary memory. The secondary memory can include, for example, a hard disk drive and/or a removable storage drive, representing a floppy disk drive, a magnetic tape drive, an optical disk drive, etc. The removable storage drive reads from and/or writes to a removable storage medium. A removable storage medium can include a floppy disk, magnetic tape, optical disk, etc., which can be removed from the storage drive used to perform read and write operations. As will be appreciated, the removable storage medium can include computer software and/or data.

In alternative embodiments, the secondary memory can include other similar means for allowing computer programs or other instructions to be loaded into a computer system. Such means can include, for example, a removable storage unit and an interface. Examples of such can include a program cartridge and cartridge interface (such as the found in video game devices), a removable memory chip (such as an EPROM or PROM) and associated socket, and other removable storage units and interfaces, which allow software and data to be transferred from the removable storage unit to the computer system.

In one embodiment, the computer system can also include a communications interface that allows software and data to be transferred between computer system and external devices. Examples of communications interfaces can include a modem, a network interface (such as, for example, an Ethernet card), a communications port, and a PCMCIA slot and card. Software and data transferred via a communications interface are in the form of signals, which can be electronic, electromagnetic, optical or other signals capable of being received by a communications interface. These signals are provided to communications interface via a channel capable of carrying signals and can be implemented using a wireless medium, wire or cable, fiber optics or other communications medium. Some examples of a channel can include a phone line, a cellular phone link, an RF link, a network interface, and other suitable communications channels.

In this document, the terms “computer program medium” and “computer usable medium” are generally used to refer to media such as a removable storage device, a disk capable of installation in a disk drive, and signals on a channel. These computer program products provide software or program instructions to a computer system.

Computer programs (also called computer control logic) are stored in the main memory and/or secondary memory. Computer programs can also be received via a communications interface. Such computer programs, when executed, enable the computer system to perform the features as discussed herein. In particular, the computer programs, when executed, enable the processor to perform the described techniques. Accordingly, such computer programs represent controllers of the computer system.

In an embodiment where the elements are implemented using software, the software can be stored in, or transmitted via, a computer program product and loaded into a computer system using, for example, a removable storage drive, hard drive or communications interface. The control logic (software), when executed by the processor, causes the processor to perform the functions of the techniques described herein.

In another embodiment, the elements are implemented primarily in hardware using, for example, hardware components such as PAL (Programmable Array Logic) devices, application specific integrated circuits (ASICs), or other suitable hardware components. Implementation of a hardware state machine so as to perform the functions described herein will be apparent to a person skilled in the relevant art(s). In yet another embodiment, elements are implanted using a combination of both hardware and software.

In another embodiment, the computer-based methods can be accessed or implemented over the World Wide Web by providing access via a Web Page to the methods described herein. Accordingly, the Web Page is identified by a Universal Resource Locator (URL). The URL denotes both the server and the particular file or page on the server. In this embodiment, it is envisioned that a client computer system interacts with a browser to select a particular URL, which in turn causes the browser to send a request for that URL or page to the server identified in the URL. Typically the server responds to the request by retrieving the requested page and transmitting the data for that page back to the requesting client computer system (the client/server interaction is typically performed in accordance with the hypertext transport protocol or HTTP). The selected page is then displayed to the user on the client's display screen. The client can then cause the server containing a computer program to launch an application to, for example, perform an analysis according to the described techniques. In another implementation, the server can download an application to be run on the client to perform an analysis according to the described techniques.

Although the systems and methods have been described in detail, it will be apparent to those of skill in the art that the systems and methods can be embodied in a variety of specific forms and that various changes, substitutions, and alterations can be made without departing from the spirit and scope of the systems and methods described herein. The described embodiments are only illustrative and not restrictive and the scope of the systems and methods is, therefore, indicated by the following claims. Other embodiments are within the scope of the following claims.

What is claimed is:

1. A method for processing information comprising:
obtaining a first amount and a second amount from a transaction,
comparing the first amount and the second amount,
entering a transaction value into a database based on the first amount and the second amount, and
flagging the transaction value in a database when the transaction value differs by one digit from the first or second amount, or when the transaction value differs from the second amount and the second amount is determined to have a specified degree of accuracy.

2. The method of claim 1, wherein obtaining the first amount and the second amount includes scanning a document.

3. The method of claim 2, wherein the first amount and the second amount are compared electronically.

4. The method of claim 1, further comprising sending a flagged transaction value to an operator.

5. The method of claim 4, wherein the operator analyzes at least one of the transaction value and first and second amounts.

6. The method of claim 1, further comprising flagging the transaction value in a database when the transaction value differs from the first or second amount by a factor of ten.

7. The method of claim 1, further comprising flagging the transaction value in a database when the transaction value differs from the first or second amount by a factor of one hundred.

8. The method of claim 1, further comprising, before flagging said transaction value, manually entering a transaction value into a database if the first amount is not the same as the second amount.

9. The method of claim 1, further comprising flagging the transaction value in a database if the first amount contains a double key press.

10. The method of claim 1, wherein the specified degree of accuracy is at least 80 percent.

11. The method of claim 1, wherein the specified degree of accuracy is at least 90 percent.

12. A method for processing information comprising:
determining a first value and a second value of a document,
comparing the first value to the second value,
entering a document value based on the first value and the second value, and
flagging the document value in a database if the length of the document value differs by one character from the length of either one of the first and second values, or when the document value differs from either one of the first and second values and the either one of the first and second values is determined to have a specified degree of accuracy.

13. The method of claim 12, wherein determining the first value and the second value includes scanning the document.

14. The method of claim 13, wherein the first value and the second value are compared electronically.

15. The method of claim 12, further comprising sending a flagged document value to an operator.

16. The method of claim 15, wherein the operator analyzes at least one of the document value and first and second values.

17. The method of claim 12, further comprising flagging the document value in a database when the document value differs from the first or second value by a factor of ten.

18. The method of claim 12, further comprising flagging the document value in a database when the document value differs from the first or second value by a factor of one hundred.

19. The method of claim 12, further comprising, before flagging said document value, manually entering a document value into a database if the first value is not the same as the second value.

20. The method of claim 12, further comprising flagging the document value in a database if the first amount contains a double key press.

21. The method of claim 12 wherein the specified degree of accuracy is 80 percent.

22. The method of claim 21, wherein the specified degree of accuracy is at least 90 percent.

23. A system for processing information comprising:
a scanner configured to obtain a first value and a second value from a document; and
a comparison module configured to compare the first value to the second value thereby identifying a predetermined error.

24. The system of claim 23, further comprising a correction module configured to receive a corrected value for the document.

25. A system according to claim 23, wherein the document is a negotiable instrument.

26. The system according to claim 23, wherein the first value is a courtesy amount.

27. The system according to claim 26, wherein the second value is a legal amount.

28. The system according to claim 23, wherein said predetermined error comprises a double key press.

29. The system according to claim 23, wherein said predetermined error comprises a difference of a factor of ten between the first or second value and a document value.

30. The system according to claim 23, wherein said predetermined error comprises a difference of one digit between either the first value or second value and a document value.

31. The system according to claim 23, wherein said predetermined error comprises a difference between either the first value or second value and a document value.
